(19) United States
(12) Patent Application Publication
(10) Pub. No.: US 2012/0308690 A1
(43) Pub. Date: Dec. 6, 2012

(54) MICROWAVABLE FILM PACKAGE HAVING STEAM VENTING FEATURE

(75) Inventor: Seth G. Holmen, Ames, IA (US)

(73) Assignee: American Packaging Corporation, Columbus, WI (US)

(21) Appl. No.: 13/489,009

(22) Filed: Jun. 5, 2012

Related U.S. Application Data
(60) Provisional application No. 61/493,682, filed on Jun. 6, 2011.
(60) Provisional application No. 61/499,119, filed on Jun. 20, 2011.

(51) Int. Cl. B65D 75/62; B26D 3/08; B29C 35/08; B65D 81/34; B32B 3/30

(52) U.S. Cl. 426/107; 428/156; 264/400; 83/880

(57) ABSTRACT

Film is used as a bladder that expands in response to an increase in the internal pressure while contents are heated, such as micro-waved. A laser-scored vent(s) is provided with scoring of an reduced extensibility layer, such that expansion of the package due to internal pressure (steam) pulls the film across the width of the package causing it to stretch to the point that the vent point(s) breaks through or ruptures the sealant film allowing the pressure/steam to escape.

This application claims priority under 35 U.S.C. §119 from the following U.S. Provisional Patent Applications, U.S. Ser. No. 61/493,682 for MICROWAVABLE FILM PACKAGE HAVING STEAM VENTING FEATURE, filed Jun. 6, 2011 by S. Holmen, and U.S. Ser. No. 61/499,119 for MICROWAVABLE FILM PACKAGE HAVING STEAM VENTING FEATURE, filed Jun. 20, 2011 by S. Holmen, both of which are hereby incorporated by reference in their entirety.

Disclosed herein is a flexible package having steam vent. Film is used as a bladder that expands in response to an increase in the internal pressure while contents of the package are micro-waved. A laser-scored or similarly-produced vent(s) is provided, for example via scoring of an oriented PET or OPP layer, such that at least a region of the package exhibits differential elasticity for the surface, where the package is intact under normal (frozen or refrigerated conditions) and expansion of the package occurs due to internal pressure (e.g., steam) that builds up during heating (e.g. micro-waving) and causes some portions of the surface fail thereby creating vents. More specifically, the pressure build-up stresses the film of the package causing it to stretch to the point that only the vent point(s) fails and causes holes to appear in the sealant film, thereby allowing the pressure/steam to escape.

### BACKGROUND AND SUMMARY

It is known in the packaging industry that the use of ventable packaging, particularly packaging that is microwavable, is advantageous. Several techniques have been employed to facilitate venting, including labels that expose a vent hole (e.g., APC's Estersteam® and Avery's Flexis Steam), laser scoring, Vacsys™ as well as heat seal coatings and controlled lamination failures. There are, however, various advantages and disadvantages with these known techniques. For example, several of the techniques might preclude hermetic sealing or otherwise risk an open package. With respect to packages containing foodstuffs the presence of vents is further complicated when the packages must contain sauces without the risk of leaking. And, even when vents are provided, there remains a problem of controlling the size of a vent(s) on a consistent basis so as to assure a consistent product/package experience.

Although several embodiments described herein are directed to laser-scored packaging, it will be appreciated that alternative scoring techniques may be employed to achieve the same functionality in a package. With respect to laser-scored packages, scoring film is a technology that may be employed for steam venting. The patterns that may be used for scoring vary greatly from continuous scores to perforations. Key challenges in laser-scoring include: (a) difficulty in ensuring the package is hermetic, and remains so until use; (b) achieving a consistent location for venting, so as to avoid spillage while cooking, and providing a package that can be handled once heated; (c) consistently controlling the score depth from job to job in view of potential material variations; and (d) preventing the scored areas from tear propagation due to building pressure inside the package.

In the package embodiments disclosed herein an improved packaging film and system is disclosed. The packaging system also addresses key challenges found with other technologies. In particular, various embodiments of the system do not require an added label or coating resulting in higher costs and more complex manufacturing processes; and is not subject to tear propagation at or around the steam vent area. The disclosed embodiments result in a self-regulating vent hole size (i.e., higher temperature/pressure, greater vent hole size), yet maintain a hermetic package until use. And, the disclosed vent hole system can be incorporated it into an easy open mechanism.

Disclosed in embodiments herein is a microwavable package, comprising: an enclosure having one or more film surfaces; at least one film surface of the enclosure forming a portion of the enclosure, said film surface including at least one vent section, wherein the vent section includes a pressure-responsive vent along a scored or modified portion of the film surface.

Further disclosed in embodiments herein is a multi-layer film package, comprising: an enclosure formed substantially of a multi-layer structure with differently extensible layers (e.g., an oriented film layer laminated to a sealant film) said enclosure being filled with a microwavable material (e.g., foodstuff) which is sealed therein; and at least a portion of one film surface including a scored region across the oriented layer surface, said scored region having a surface deformation of variable depth, wherein the depth periodically extends through at least the oriented layer(s) of the film such that heating of the package contents causes expansion of the package and stretching of the film surface and thereby the creation of vent points at least where the scoring penetrated at least the oriented layer(s).

Also disclosed herein is a method of manufacturing a flexible film for use on a steam venting package, comprising: providing a flexible film; and scoring a layer of the flexible film to produce a layer of the film exhibiting a reduced extensibility relative to at least an adjacent layer of the flexible film, and thereby producing a pressure-responsive region of the film.

### BRIEF DESCRIPTION OF THE DRAWINGS

FIG. 1 is a top view of a sealant film employed for a package surface in accordance with the disclosed embodiments;

FIGS. 2A-2C are illustrative examples of a packaging film scored in accordance with the disclosed embodiments, showing the progressive change in the scored vent region;

FIG. 3A is a cross-sectional illustration along line A-A1 in FIG. 2A, showing the relative depth of the differential laser scoring of the film in accordance with one of the disclosed embodiments;

FIG. 3B is cross-sectional illustration of a co-extruded film with a scored surface in accordance with an alternative embodiment;

FIG. 4 is an illustrative example showing the surface of a film scored in the manner indicated and the opening of vent points in response to pressure in the package;

FIGS. 5A and 5B are cross-sectional illustrations showing film alyers in accordance with alternative embodiments;

FIG. 6 is an illustrative example of an alternative embodiment for the disclosed package;

FIG. 7 is an illustrative example of another alternative embodiment for the disclosed package; and

FIG. 8 is an illustrative example of an alternative package employing a venting film.

The various embodiments described herein are not intended to limit the disclosure to those embodiments described. On the contrary, the intent is to cover all alternatives, modifications, and equivalents as may be included within the spirit and scope of the various embodiments and equivalents set forth. For a general understanding, reference is made to the drawings. In the drawings, like references have been used throughout to designate identical or similar elements. It is also noted that the drawings may not have been drawn to scale and that certain regions may have been purposely drawn disproportionately so that the features and aspects could be properly depicted.

### DETAILED DESCRIPTION

Although described relative to a packaging film surface in several of the following embodiments, it will be appreciated that the disclosed venting system may be incorporated into any package that employs or can be modified to include at least one film surface into which the venting system may be incorporated. Moreover, the term package is intended to include any of a number of configurations, shapes and sizes that may be used for the heating or preparation of foodstuffs as well as other materials, including bags (e.g., flat-bottomed and side-gusseted) and lidding materials. Furthermore, the various differently extensible substrates may include paper and cellophane (cellulose-based films) as well as various combinations of the materials disclosed herein.

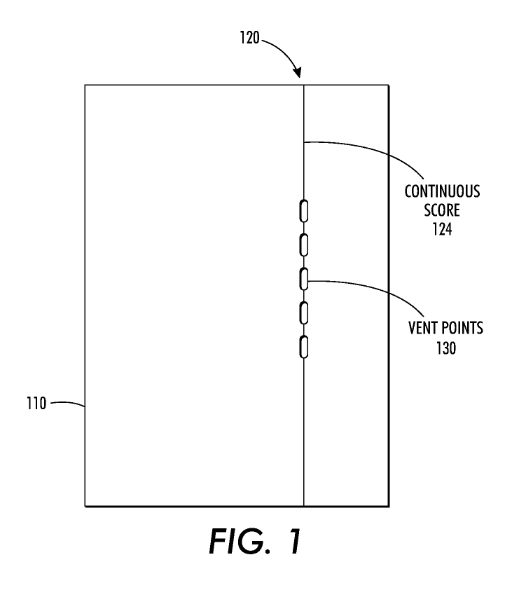

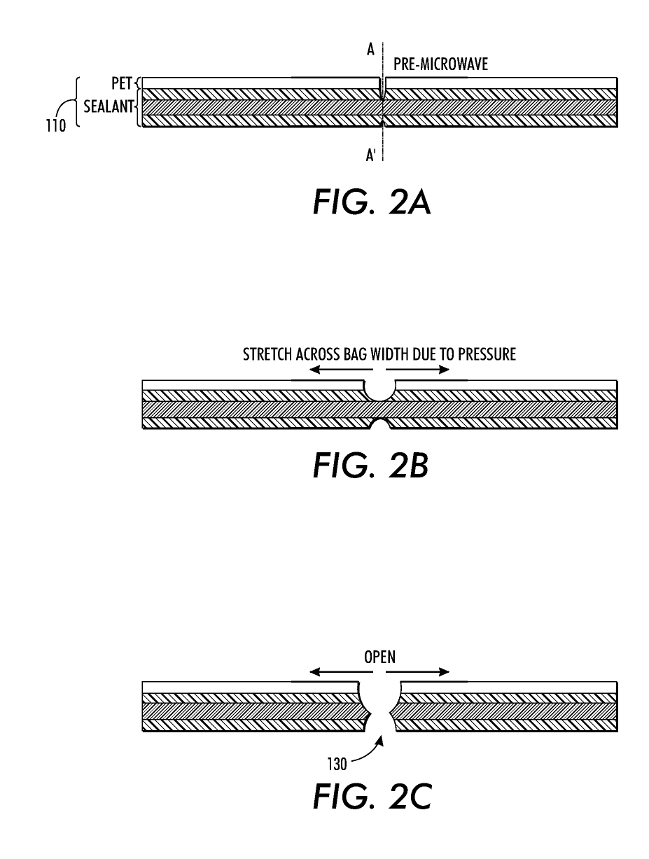

Referring to FIGS. 1 and 2A-2C, depicted therein are top and cross-sectional views of the multi-layer film having one or more sealant layers plus at least an outer or top layer of an oriented material such as oriented polyester (PET), oriented polypropylene (OPP), or biaxially oriented Nylon (BON). Such films are produced and sold by a variety of companies, including Polyplex TFC, DuPont Mylar, SKC SP-65, and Flex F-PAP. The films may include separate oriented layers that are adhesive or extrusion laminated to an inner film or layer to provide a package structure with oriented PET or OPP, for example, laminated to a coextruded sealant film. In general, a sealant film is produced from a resin such as polyethylene and/or polypropylene that may be responsive to heating in order to bond or adhere to other layers. Further contemplated are combinations of sealant materials in the form of blends or layers of such materials. As will be described relative to alternative materials below, it is possible to employ a single material yet cause a top layer of the material to have a differential or reduced extensibility, and there by achieve the equivalent of a layered film having oriented materials.

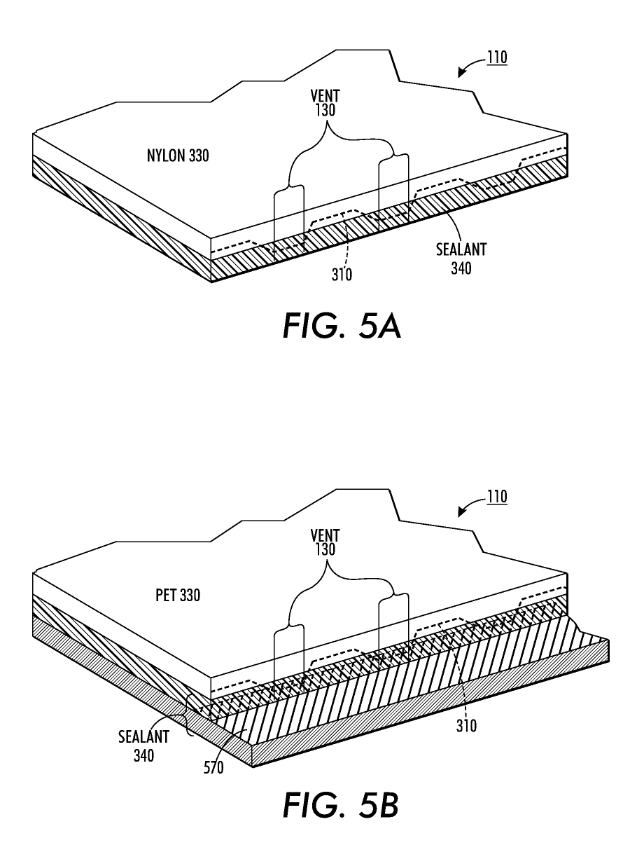

In one embodiment, the film provides a differential score capability. Depicted along the surface of film 110 of FIG. 1 is a laser score line that is continuous along region 124 and is deeper and/or wider so as to be differential along its length and results in vent points 130. Although described as continuous along a region 124, as depicted in FIG. 5, the region 124 may only be over a portion of the package surface, and while continuous it does not have to be linear as illustrated in FIG. 1. To achieve the differential scoring, the power of the laser used for scoring is controlled, or more specifically modulated so as to just penetrate the oriented PET layer. Moreover, the differential or deeper scoring may be done in registration with the graphics that may be present on a surface of the package, providing both a continuous score and vent points (see FIG. 5).

As illustrated in FIGS. 2B and 2C, as the differentially scored film is stretched in the direction indicated by the arrows (across the laser-scored line), the more deeply scored portions of the film are pulled apart so as to open a vent in region 130. It will be appreciated that the size of the vent opening is, to some extent, dependent upon the size of vent scoring as well as the pressure and temperature inside the package. As indicated in FIGS. 2A-2C, the film is three layers, such that laser energy passes through the PET film, two similarly-cross-hatched layers absorb more than the alternatively cross-hatched layer (middle) which permits the differential scoring with the laser. It may be possible to include more layers, including up to five or even seven layers. And it may further be possible, as suggested above, to use a monolayer sealant film. As described herein one aspect of the disclosed embodiments is that the package surface simply needs to have an outer layer that is less elastic (reduced extensibility) than the inner layer, where disrupting the outer layer by scoring (e.g., laser, mechanical) or similar methods, results in a packaging material that will self-vent when the package is expanded or otherwise placed under strain. As will be appreciated this would also allow the use of high-density polyethylene (HDPE) as an outer film layer.

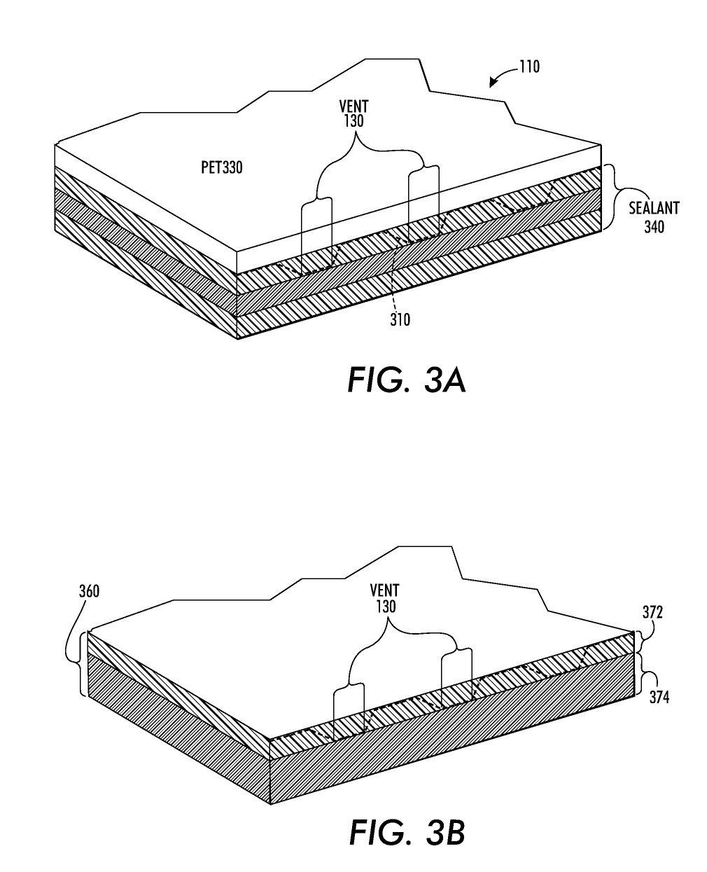

Referring also to FIG. 3A, depicted therein is a cross-section of the film of FIG. 2A, taken along line A-A′, wherein the relative depth of the differentially scored line 310 is illustrated. As illustrated by the change in depth, the scoring of the laser is controlled so that the continuous score penetrates through the PET or other oriented film layer 330 but not into the underlying layers. whereas the vent regions are formed by scoring that penetrates through the PET layer and even into the sub-layer(s) (underlying layers) of the film, although not entirely through any sealant layer 340. Although illustrated as regularly spaced and having similar widths, it will be appreciated that further control of the vent sizes and shapes, and associated vent release pressure, may be accomplished through control of the location, frequency, size and shape of vent points along the length of the continuous score, and that vents of varying depths/sizes may be included so as to assure that some early venting occurs at a lower pressure and that additional vents open up in response to higher temperatures and pressures inside the package.

Also referring to FIG. 3B, depicted therein is a cross-section of an alternative film that may be a co-extruded film. As noted briefly above, it is possible to employ a single material or non-laminated structure, yet still cause a top layer of the material to have a differential or reduced extensibility via scoring or other “working” of the surface. Such a structure will exhibit a reduced extensibility or lower elasticity in the worked region, thereby resulting in regions that will rupture at lower levels of stress to provide vent holes in the film. More specifically, a co-extruded film 360 may be produced having a single or multi-layered structure, wherein at least a portion of the film is operated on by working a surface 372 (e.g., laser scoring) so as to create vent locations 130 that open when the film is stretched causing a rupture to occur in the non-worked layer 374. Although illustrated as regularly spaced and having similar widths, it will be appreciated that the vent sizes and shapes may be accomplished through control of the location, frequency, size and shape of vent points. And that variation in the characteristics of the scoring or working of the film may in turn provide control over the pressure or amount of stretch that is required to cause the vents to open. Moreover, as with the alternative embodiments, vents of varying depths/sizes may be included to assure that some early venting occurs at a lower pressure and that additional vents open up in response to higher temperatures and pressures inside the package.

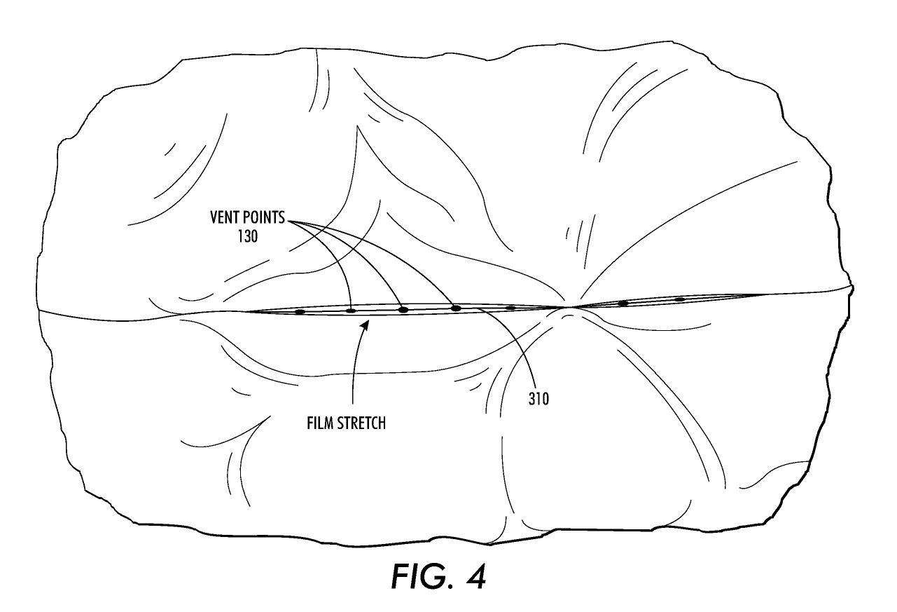

Referring also to FIG. 4, the sealant film is used as a bladder that expands with increase in the internal pressure of the package. Expansion is allowed because the oriented PET layer has been scored, and the underlying sealant layer(s) are not constrained by the PET. As illustrated by the vent points 130 in FIG. 4, the expansion pulls on the sealant film across the width of the bag causing it to stretch to the point that the vent points break through the sealant film and allow steam to escape. As noted above, higher pressures cause the film to stretch more, which in turn opens the vents further. Thus the vents are self-adjusting in nature.

Referring to FIG. 5A, also contemplated is the potential to use a single substrate that has multiple layers, each layer having differences in extensibility or elasticity relative to other layers. Such a packaging material may permit additional design flexibility for venting in that differential scoring of one or more layers may permit further control of the venting process and thereby strain at which vents form (i.e., venting pressure). For example, it may be possible to use a coextruded film with a Nylon surface on one of the exterior layers 330. The Nylon would act as the oriented layer described above, and any discontinuities created in the outer layer 330 would ultimately provide vent points as a result of the expansion and rupture of the sealant layer.

And, referring also to FIG. 5B, further contemplated is the use of a registered coating or similar inter-layer structure 570, wherein the registered coating is provided within the lamination layers, in the vent regions, and facilitates the separation of the oriented layer and sealant layer to improve the responsiveness of the sealant layer to the applied strain (i.e., resulting in easier rupture). For example, the inter-layer structure may be achieved by using a registered coating process, wherein either an additional coating layer, or no layer, is provided in the region so as to produce a different structure 570 where the vents are to occur. The, with a further disruption in the outer surface, the venting is more readily achieved and controlled. Such a packaging material would further maximize the effects of the bladder and enable improved control of the vent holes.

Also contemplated as alternatives are the location of the vent scoring, such that the film wants to stretch. Typically this would be at the center of the bag or package, but other locations could be used. Moreover, the shape of the bag or packaging plays a roll, and the scoring is believed to be most advantageous be across a short package dimension. Typically the package wants to become a ball, so the short bag width is what wants to stretch more—i.e., a score perpendicular to short bag width. It is also contemplated that the thickness of the sealant film could be adjusted or variable so as to vary the time or strain necessary to cause stretching or opening of the vents.

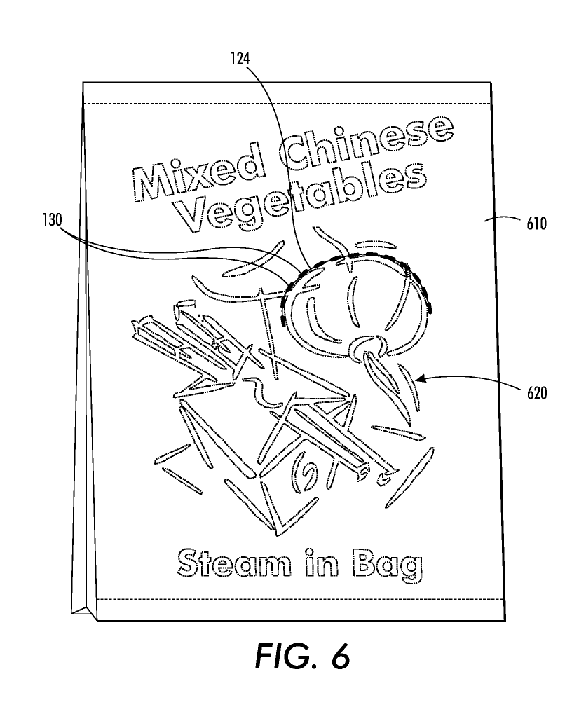

As an illustration of alternative vent scoring or positions, reference is made to FIG. 6, where a pleated package of frozen Chinese vegetables is illustrated. The bag of vegetables 610 includes a flexible outer package surface that has a short arc of continuous scoring that results in a plurality of vent holes 130 upon expansion of the packaging material. More specifically, package 610 includes graphics 620 as illustrated. The continuous score 124 is not down the entire length of the package as previously described, but may be registered, at least in part, to the graphics, with the vent points still contained only in areas that have the “continuous score”. In this way the vent points may be “hidden” or, in some embodiments “emphasized.”

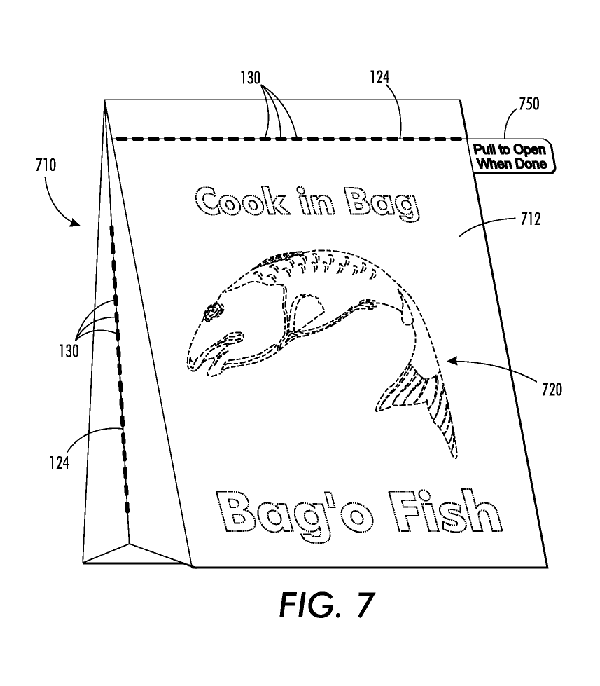

A similar embodiment is illustrated in FIG. 7, where the continuous score line 124 is located along the top of the package and is further associated with a region of the bag that is to be opened, or alternatively along or on a portion of the side of the pleated package 710. The pleated package 710 is illustrated, and includes package surface 712 that has a generally straight line of continuous scoring that results in a plurality of vent holes 130 upon expansion of the packaging material. In one embodiment, package 710 includes a tab 750 that may be further employed to tear the package along the score line/vent holes once the contents has been heated or cooked. The continuous score 124 may, as a result, be present across the entire front or side surface of the package, and may further be registered, at least in part, to the graphics. By placing the vent line 124 across the top of the package, the vent points may be “emphasized” and the scoring serves the added purpose of providing a tear-able package surface.

In summary, disclosed in the figures is a an enclosure formed substantially of a multi-layer, oriented film structure 110, where the enclosure may be filled with a microwavable material (e.g., foodstuff) which is sealed therein. At least a portion of one film surface includes a laser-scored line across the PET coated surface, where the laser-scored line has a variable depth and/or width/size. In one embodiment described above, the depth of the laser scoring periodically extends through the oriented PET coating and into a lower layer(s) of the film such that heating of the package contents causes stretching of the film surface and the creation of vent points at least where the laser-scoring penetrated the PET coating.

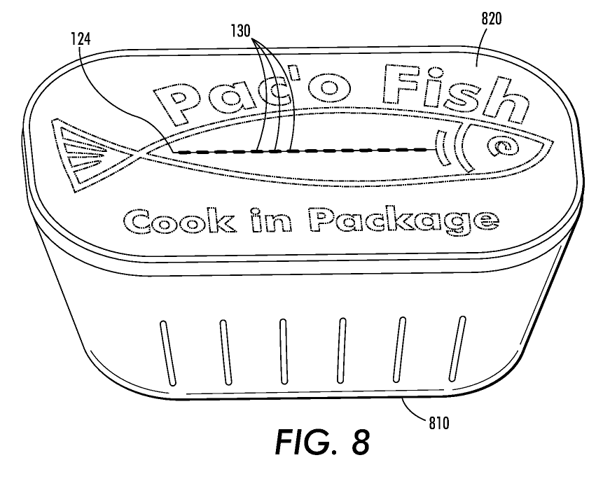

Also contemplated is a method of manufacturing a steam venting package in accordance with the features described above. As illustrated in FIGS. 6-8, various package formats may employ the techniques and materials described herein. For example, the techniques may be employed for packaging that is formed entirely of flexible film materials (e.g., FIGS. 6 and 7), as well as packaging that includes a more rigid package base and a flexible film top surface (or portion thereof) as illustrated in FIG. 8. Briefly referring to FIG. 8, the illustrated package may include a blow-molded or other type of rigid or semi-rigid base 810 into which a foodstuff or similar heatable item(s) is inserted before having a top film layer 820 applied and adhered continuously along and to a top edge of the base. The film may be adhered using a sealing adhesive and/or a heat seal causing the two materials to be bonded. The film layer, as previously described would include a portion or region in which a line 124 of scored vents 130 that would open in response to increased pressure inside the package. And, the vents would be designed to open at a pressure below which the edge seal fails.

As will be appreciated, various methods of manufacturing the flexible film, packages and, in turn packaging products, may be employed, be they formed entirely from flexible films or of combinations of rigid materials and flexible films, and the use or selection of a particular package or materials may be dependent upon the item to be packaged and the intended manner of use. Such a method would include providing a package enclosure with at least one surface formed of a multi-layer film, where at least one layer of the film includes a scored or worked region that has a reduced extensibility. The surface could be laser-scored over at least a portion of the surface to produce a differentially-scored line across the surface, where at least some of the laser-scored line penetrates into but not entirely through the underlying layer(s), thereby providing a weakened vent point where, upon expansion of the surface due to heating the vent point will fail prior to the surrounding material causing a vent to open in the surface.

Benefits of the disclosed vent design and easy opening package are that, after cooking, the package allows the consumer to tear down the length of the bag at the score line. It is also believed that the design will result in reduced sauce spillage due to the use of small vent points and the ability to position the vent points in the middle of the bag. Lastly, the disclosed package is believed to improve safety as the vents will not reseal causing implosion as the package cools, and the position of vent points can be controlled and located away from the ends where users grab the package.

It should be understood that various changes and modifications to the embodiments described herein will be apparent to those skilled in the art. Such changes and modifications can be made without departing from the spirit and scope of the present disclosure and without diminishing its intended advantages. It is therefore anticipated that all such changes and modifications be covered by the instant application.

What is claimed is:

1. A microwavable package, comprising:
a sealed enclosure including at least one flexible film, said flexible film further including a layer in the flexible film exhibiting a reduced extensibility relative to at least an adjacent layer of the flexible film to produce a pressure-responsive region of the film; and
a microwavable material entirely enclosed within said sealed enclosure,
wherein upon the application of microwave energy to the package, the microwavable material is heated and the package expands due to increased pressure in the sealed enclosure, and where localized rupture of the flexible film occurs in the pressure-responsive region.

2. The package according to claim 1, wherein at least one flexible film surface includes an oriented outer layer forming a portion of the enclosure.

3. The package according to claim 1, wherein the reduced extensibility layer is an independent film substrate that is laminated to an inner sealant film.

4. The package according to claim 3, wherein the reduced extensibility layer is selected from the group consisting of: oriented polyester, oriented polypropylene, oriented Nylon, paper and cellophane.

5. The package according to claim 4, wherein the reduced extensibility layer is extrusion laminated to the sealant film.

6. The package according to claim 4, wherein the reduced extensibility layer is adhesive laminated to the sealant film.

7. The package according to claim 1, wherein the pressure-responsive region extends continuously across at least a portion of the film surface, and where vents occur periodically within the region as pressure is increased within the package.

8. The package according to claim 3, wherein the film includes an oriented layer over a sealant layer, and where the pressure-responsive region is formed by laser-scoring through the oriented layer.

9. The package according to claim 3, wherein the pressure-responsive region is formed by scoring through the reduced extensibility layer.

10. The package according to claim 3, further including a registered coating between the inner sealant film and outer layer only in the vent point areas, said coating facilitating separation of the outer layer and sealant film.

11. A flexible packaging film suitable for use as at least a portion of a sealed package, the flexible packaging film comprising:
at least one region thereof exhibiting reduced extensibility, such that the application of a strain to the film results in the rupture of expanded portions of the film adjacent to the region exhibiting the reduced extensibility.

12. The flexible packaging film according to claim 11, wherein an increased extensibility region is exposed, at least in part, by variable depth scoring of the film.

13. The flexible packaging film according to claim 12 wherein the film includes at least one oriented outer layer and a sealant inner layer and where the depth of the scoring disrupts the at least one oriented outer layer of the film such that stretching of the film creates a rupture of the sealant layer at least where the scoring occurred.

14. The flexible packaging film of claim 13, wherein the outer layer is an independent film substrate that is laminated to an inner sealant film.

15. The flexible packaging film of claim 14, wherein the outer layer is selected from the group consisting of: oriented polyester, oriented polypropylene, oriented Nylon, paper and cellophane.

16. A method of manufacturing a flexible film for use on a steam venting package, comprising:
providing a flexible film; and
scoring a layer of the flexible film to produce a layer of the film exhibiting a reduced extensibility relative to at least an adjacent layer of the flexible film, and thereby producing a pressure-responsive region of the film.

17. The method according to claim 16, wherein providing the flexible film includes producing a laminated film.

18. The method according to claim 16, wherein scoring a layer of the flexible film to produce a layer of the film exhibiting a reduced extensibility includes scoring the film such that at least some of the scoring penetrates through an outer layer and thereby creates a vent point where, upon expansion of the film the vent point will rupture before the surrounding material causing a vent to open in the film.

19. The method according to claim 16, wherein scoring the film is a variable depth scoring.

20. The method according to claim 19, wherein scoring the film is performed using a technique selected from the group consisting of: laser scoring and mechanical scoring.
